(19) United States
(12) Patent Application Publication
(10) Pub. No.: US 2014/0069673 A1
(43) Pub. Date: Mar. 13, 2014

(54) TAMPING TOOL

(71) Applicant: William H. Jamison, II, Littleton, CO (US)

(72) Inventor: William H. Jamison, II, Littleton, CO (US)

(73) Assignee: Table Games, LLC, Littleton, CO (US)

(21) Appl. No.: 13/608,780

(22) Filed: Sep. 10, 2012

(51) Int. Cl. B25D 17/00

(52) U.S. Cl. 173/90

(57) ABSTRACT

A tamping tool is provided that allows elongated members to be driven into various materials. The tamping tool may be comprised of three elements: a body element, a flange, and a stem. The stem may be interconnected to the flange, which may be interconnected to the body element. The stem may be configured to translate a downward force applied thereto into a downward force applied to the body element. The body element is hollow such that an elongated member may at least partially fit within the tamping tool, and the force applied to the body element drives the elongated member into various materials.

### FIELD OF THE DISCLOSURE

The present disclosure relates to the driving of elongated members into various materials and tools for the same.

### BACKGROUND

When erecting high voltage, electric transmission poles, all pole installations require ground rods to be driven at each location where a pole is installed. Many other operations that utilize high power machinery, such as oil rig operations, also require ground rod installation. Such ground rods are typically ⅝″ to ¾″ in diameter and 8′ to 10′ in length. The normal installation method is to drive one rod into the earth at a desired location (e.g., next to the transmission pole or next to high power machinery).

Certain fields of application required multiple successive rods on top of any previous rod. In these scenarios, multiple individual rods are driven on top of one another until the total length of rod driven into the ground is 70′ or more. The purpose of driving such ground rods in this manner is to achieve an electrical resistance level as required by electrical design. These ground rods are connected to the new steel poles or electrical machinery using copper wire to create a path for any electrical over current condition.

Often times, the ground rod is driven into the ground by an air hammer that is held by a person standing on a ladder. As can be appreciated, this method of installing ground rods is extremely dangerous and can lead to severe injury or death.

Other solutions, such as those described in U.S. Pat. No. 7,410,008 to Jahnigen, the entire contents of which are hereby incorporated herein by reference, employ motorized driving mechanisms that can be attached to a Skid Steer or the like. The drawback to such a solution is that Skid Steers are not always available at every location where a ground rod is needed or it may be commercially impractical to use such automated machinery when hand-held tools are available as a more cost-effective alternative.

### SUMMARY

It is, therefore, one aspect of the present disclosure to provide a hand-held tool that is capable of driving a ground rod or other type of article into an object, such as the Earth. Although embodiments of the present disclosure will be described primarily in connection with the driving of ground rods, it should be appreciated that the invention is not so limited. Specifically, the aspects described herein can be implemented in any type of tool (hand-held or automated) to enable a safer and more cost-effective way to drive one object into another object.

In some embodiments, a tamping tool is provided that includes a body having a first end and a second end. A flange may be operatively associated with the second end of the body and may extend radially from the body. The flange may include a top surface, an opposing bottom surface, and at least one edge connecting the top surface to the bottom surface. A stem may then be interconnected to the body via the flange. In some embodiments, the stem may be positioned laterally away from the body on the top surface of the flange. The stem may be configured to accommodate an air hammer or the like to apply a downward force on to the surface of the flange. The downward force applied to the top surface of the flange via the stem may be translated into a downward force applied to the body. This downward force applied to the body may then be used to drive an object, such as a ground rod, into another object, such as Earth or some other common voltage point.

Advantageously, the tamping tool provided herein is easily portable to locations where a Skid Steer or other automated equipment may not be available. Moreover, the tamping tool provided herein allows the user to stand safely on the ground while applying a downward force on a ground rod that might be of a height between 7′ and 10′. With a rigid construction the tamping tool disclosed herein provides a useful option between the

### BRIEF DESCRIPTION OF THE DRAWINGS

The present disclosure is described in conjunction with the appended figures:

FIG. 1 is an isometric view of a tamping tool in accordance with embodiments of the present disclosure;

FIG. 2 is a further isometric view of the tamping tool depicted in FIG. 1;

FIG. 3 is a cross-sectional view of a tamping tool in accordance with embodiments of the present disclosure;

FIG. 4 is a side view of a tamping tool in accordance with embodiments of the present disclosure;

FIG. 5 is a side view of a tamping tool in accordance with embodiments of the present disclosure;

FIG. 6 is a side view of a tamping tool in accordance with embodiments of the present disclosure;

FIG. 7 is a side view of a tamping tool in accordance with embodiments of the present disclosure;

FIG. 8 is a side view of a tamping tool in accordance with embodiments of the present disclosure;

FIG. 9 is a side view of a tamping tool in accordance with embodiments of the present disclosure;

FIG. 10 is a side view of a tamping tool in accordance with embodiments of the present disclosure;

FIG. 11 is a side view of a tamping tool in accordance with embodiments of the present disclosure;

FIG. 12 is a side view of a tamping tool in accordance with embodiments of the present disclosure;

FIG. 13A is a side view of a tamping tool and a stem cap in accordance with embodiments of the present disclosure; and

FIG. 13B is a side view of a tamping tool and a stem cap in accordance with embodiments of the present disclosure.

### DETAILED DESCRIPTION

The ensuing description provides embodiments only, and is not intended to limit the scope, applicability, or configuration of the claims. Rather, the ensuing description will provide those skilled in the art with an enabling description for implementing the described embodiments. It being understood that various changes may be made in the function and arrangement of elements without departing from the spirit and scope of the appended claims.

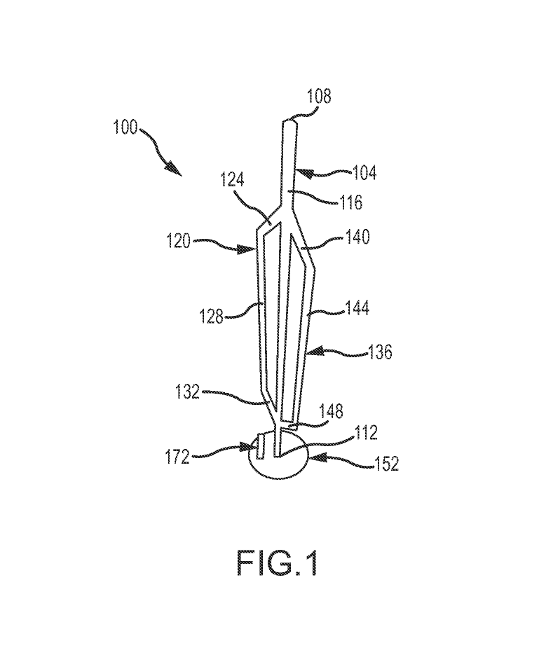

FIG. 1 shows one embodiment of the present disclosure which is comprised of a body element 104, a first handle 120, a second handle 136, a flange 152, and a stem 172. An interior space 196 within the body element 104 and flange 152 fits over an elongated member such as a guiding rod. A pneumatic power source is selectively interconnected with the stem 172 to provide pneumatic pulses to the tamping tool 100, and the pulses allow the tamping tool 100 to drive an elongated member into various materials such as soil.

The tamping tool 100 has a body element 104 which is oriented substantially vertically and fits over at least a portion of an elongated member. The body element 104 has a first end 108 and a second end 112. In the depicted embodiment, the first end 108 and second end 112 are joined by a cylindrically-shaped edge 116.

As shown in FIG. 1, a handle or handles may be interconnected to the body element 104 of the tamping tool 100 to aid in controlling the device during operation. A first handle 120 and a second handle 136 are interconnected to the body element 104, and both handles have three sections: a first section, a second section, and a third section. For the first handle 120, the first section 124 is interconnected to the body element 104. The first section 124 then extends away from the body element 104, and it extends downwardly at an angle below a horizontal plane. At its second terminus, the first section 124 is interconnected to a second section 128. The second section 128 is oriented substantially parallel to the body element 104 and extends downwardly. At its second terminus, the second section 128 is interconnected to a third section 132. The third section 132 extends toward the body element 104, and it extends downwardly at an angle below a horizontal plane. The third section 132 extends until it is interconnected with the body element 104. The second handle 136 may exhibit bilateral symmetry about a plane which travels through the vertical axis of the body element 104. In other words, the first section 140, second section 144, and third section 148 of the second handle 136 mirror the corresponding sections of the first handle 120.

A person who is skilled in the art will recognize that the present disclosure may have various handle configurations that are advantageous. The present disclosure may have various numbers of sections per handle with differing points of interconnection to each other and to the body element 104. Even the number of handle may differ. Further, it may be advantageous to have multiple handles demonstrate symmetry about a plane or axis, or it may be advantageous to have multiple handles demonstrate asymmetry.

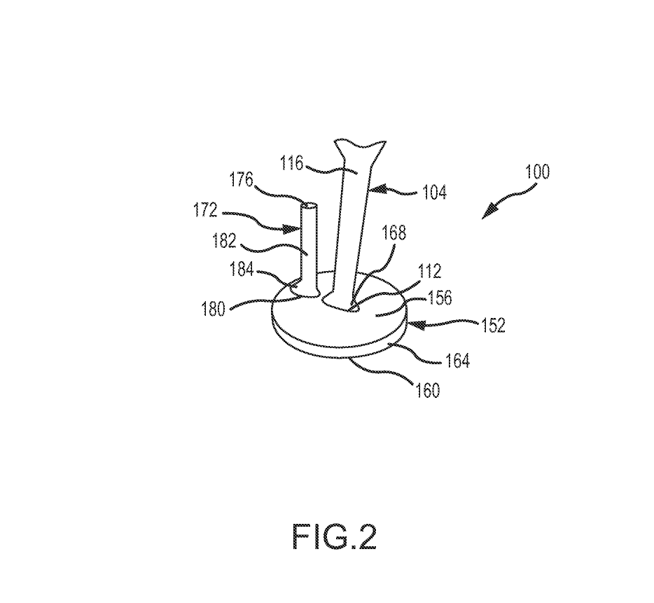

FIG. 2 shows a closer view of the lower region of the tamping tool 100 from the same embodiment depicted in FIG. 1. The flange 152 has a first end 156 and a second end 160. In this embodiment, these two ends are joined by a cylindrical edge 164. Further, the second end 112 of the body element 104 is interconnected with the first end 156 of the flange 152. In other embodiments, a person who is skilled in the art may find other points of interconnection between the body element 104 and the flange 152 advantageous. For example, an interconnection between the second end 112 of the body element 104 and the second end 160 of the flange 152. The flange 152 may also interconnect with the body element 104 at a point between the first end 108 and the second end 112 of the flange body element 104.

In the depicted embodiment, a joining region 168 may surround the interconnection between the body element 104 and the flange 152. This joining region 168 may be the sole mechanism to secure the two elements, or the joining region 168 may aid another mechanism which secures the two elements. It is also possible that the joining region 168 may serve another purpose altogether such as the dissipation of mechanical stresses which would otherwise accumulate if the interconnection between the body element 104 and the flange 152 was a flush 90 degrees. It should be understood that the aforementioned roles for the joining region 168 are not exhaustive or necessarily exclusive to one another.

The stem 172 has a first end 176 and a second end 180, and the two ends are joined by a cylindrical edge 182. Like the body element 104, the second end 180 of the stem 172 is interconnected with the first end 156 of the flange 152. In other embodiments, a person who is skilled in the art may find other points of interconnection between the body element 104 and the flange 152 advantageous. For example, an interconnection between the second end 180 of the stem 172 and the second end 160 of the flange 152. The flange 152 may interconnect with the stem 172 at a point between the first end 176 and the second end 180 of the flange 172.

Also like the body element 104-flange 152 interconnection, a joining region 184 may surround the interconnection between the stem 172 and the flange 152. This joining region 184 may be the sole mechanism to secure the two elements, or the joining region 184 may aid another mechanism which secures the two elements. It is also possible that the joining region 184 may serve another purpose altogether such as the dissipation of mechanical stresses which would otherwise accumulate if the interconnection between the stem 172 and the flange 152 was a flush 90 degrees. It should be understood that the aforementioned roles for the joining region 184 are not exhaustive or necessarily exclusive to one another.

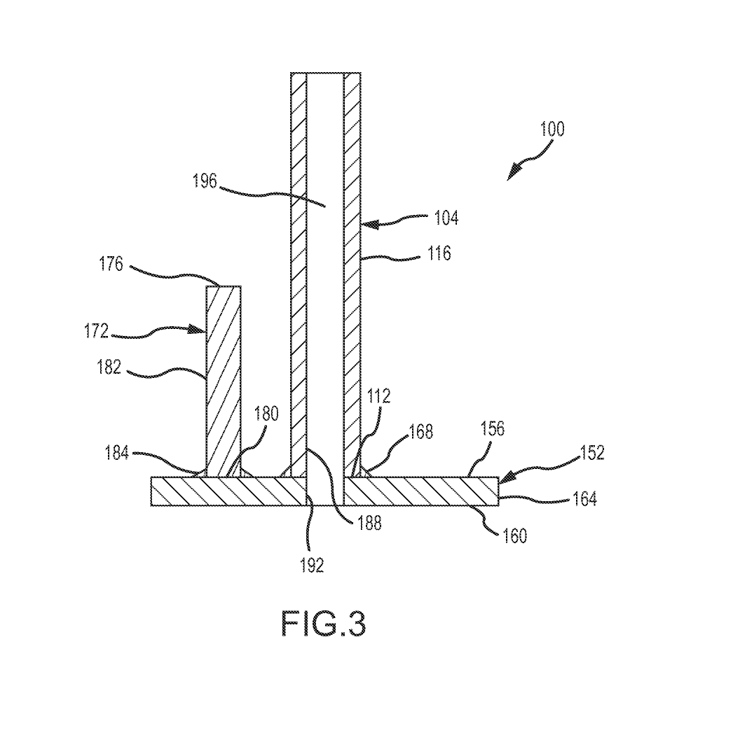

FIG. 3 shows a cross-sectional view of one embodiment of the tamping tool 100. In this view, the joining regions 168, 184 are more clearly distinguishable from the body element 104, flange 152, and stem 172. Further, the cross-sectional view shows that the body element 104 and flange 152 have interior surfaces 188, 192 which are cylindrically-shaped. The interior surface 188 of the body element 104 and the interior surface 192 of the flange 152 create an interior space 196 within the tamping tool 100. This space 196 will accommodate, and at least partially cover, an elongated member.

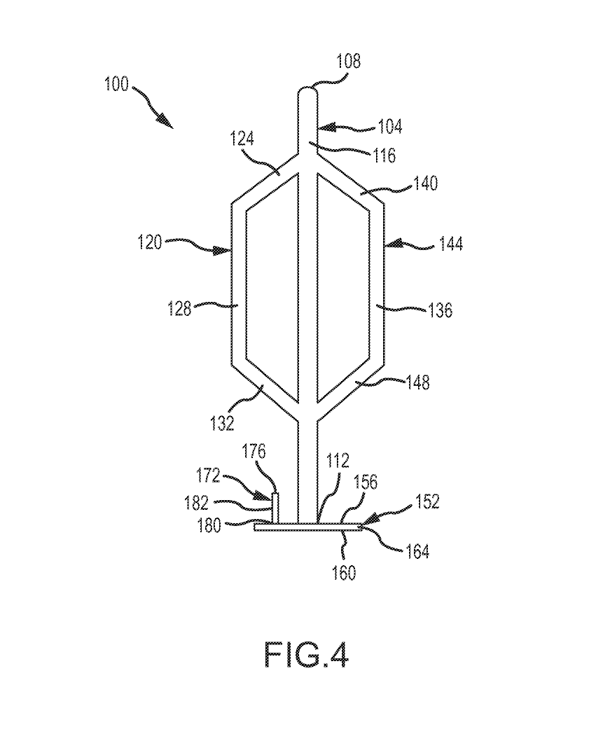

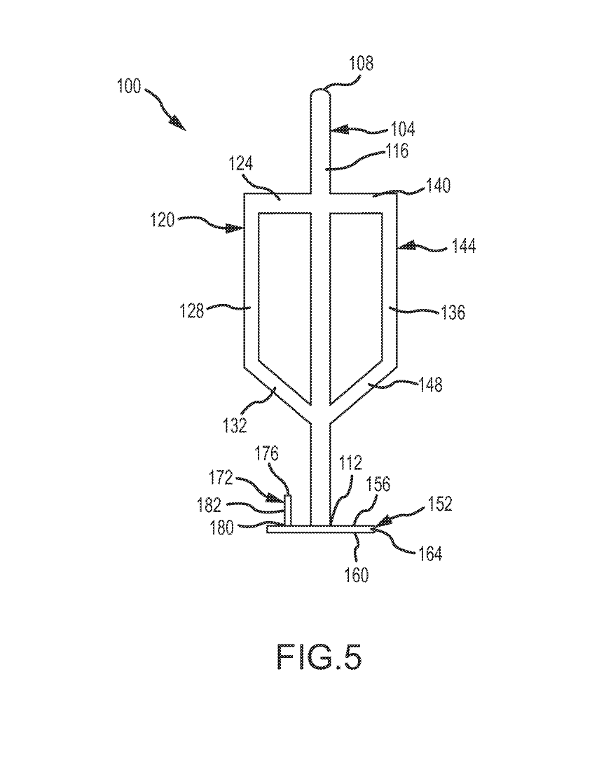

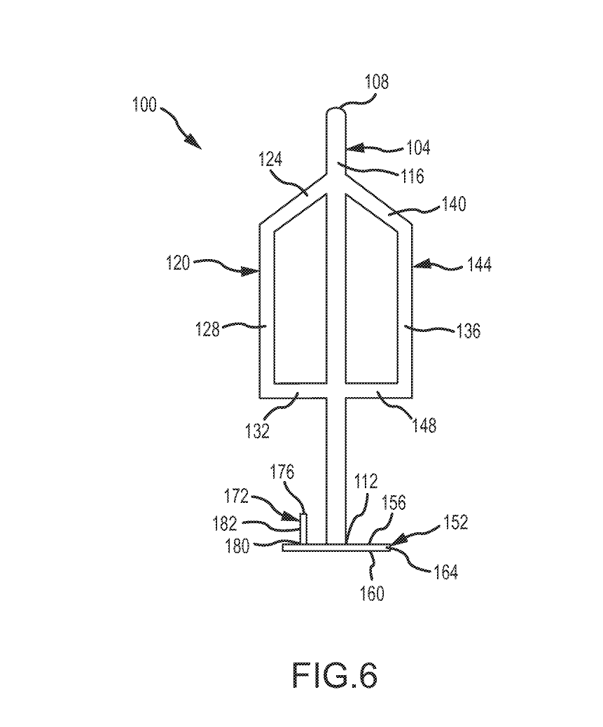

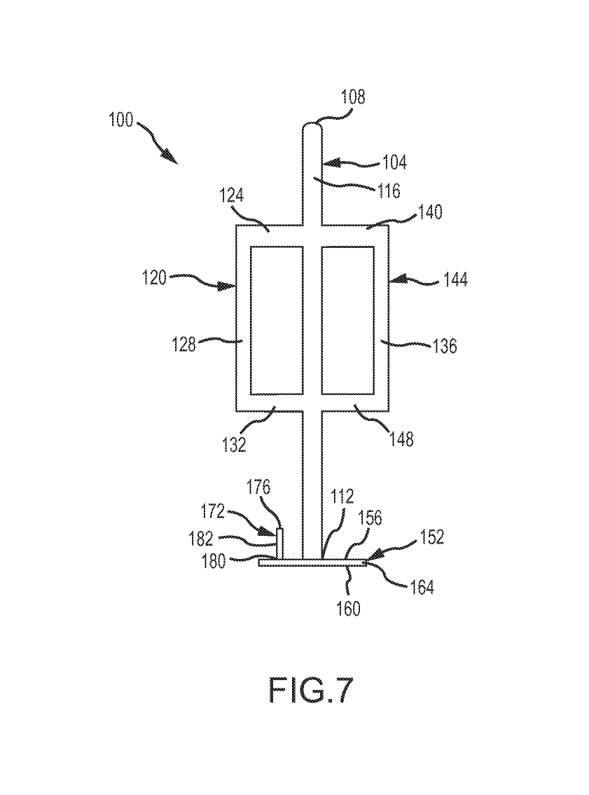

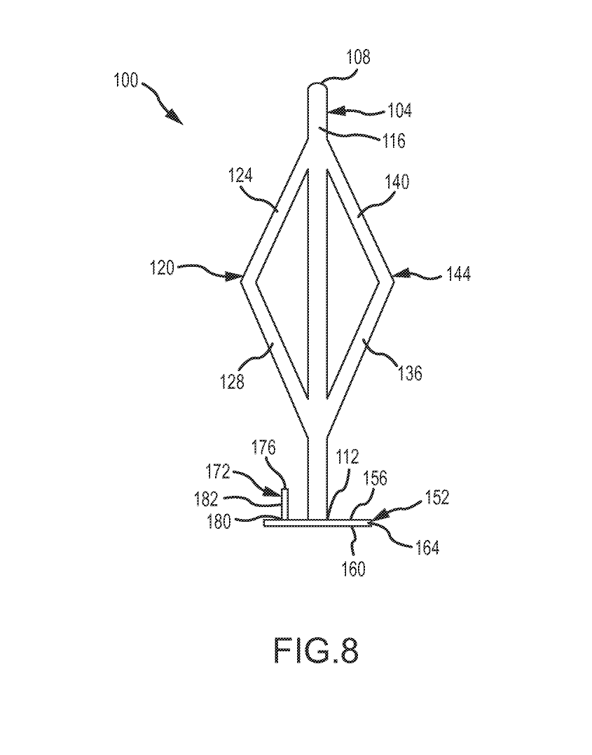

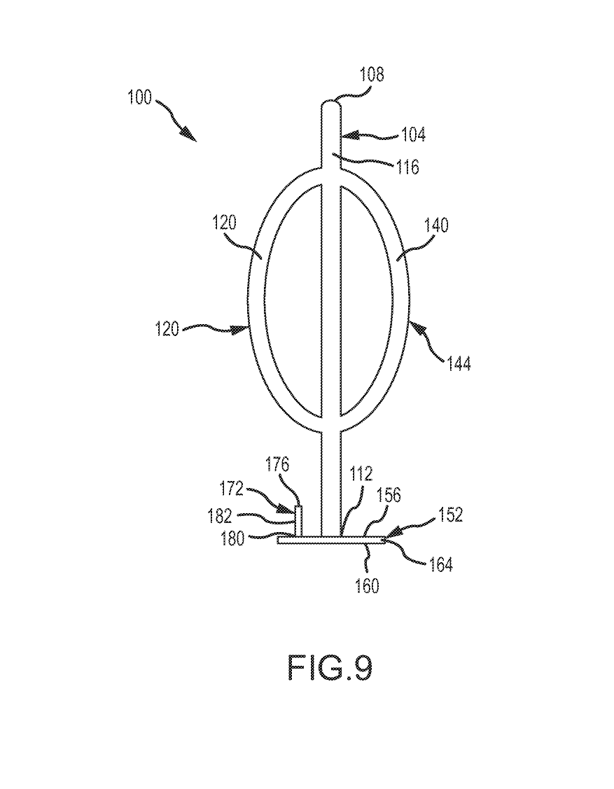

FIG. 4 is a side view of the embodiment depicted in FIG. 1, and FIGS. 5 to 12 are side views of additional embodiments of the present disclosure. These additional embodiments demonstrate some variations of the handles 120, 144 interconnected to the body element 104. FIGS. 5, 6, and 7 demonstrate different arrangements for three-sectioned handles. FIG. 8 demonstrates a first handle 120 with two sections 124, 128, and FIG. 9 demonstrates a first handle 120 with a single section 124.

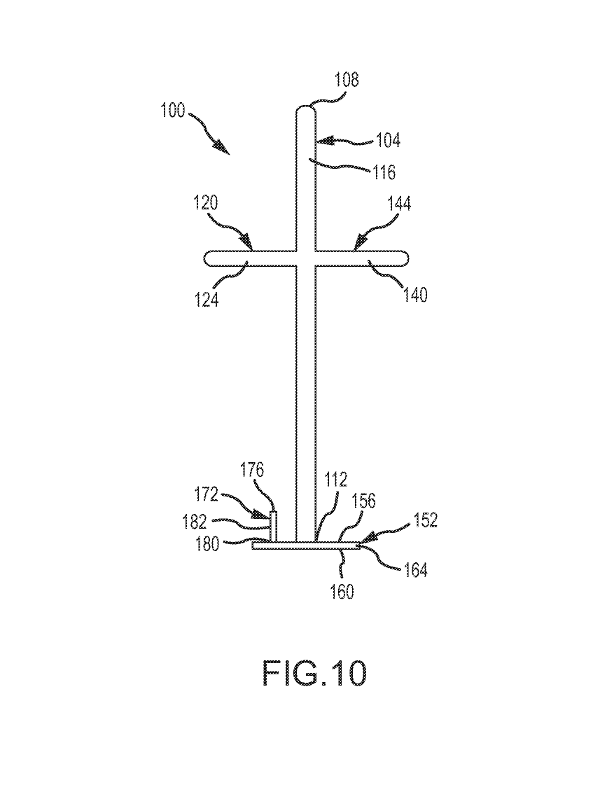

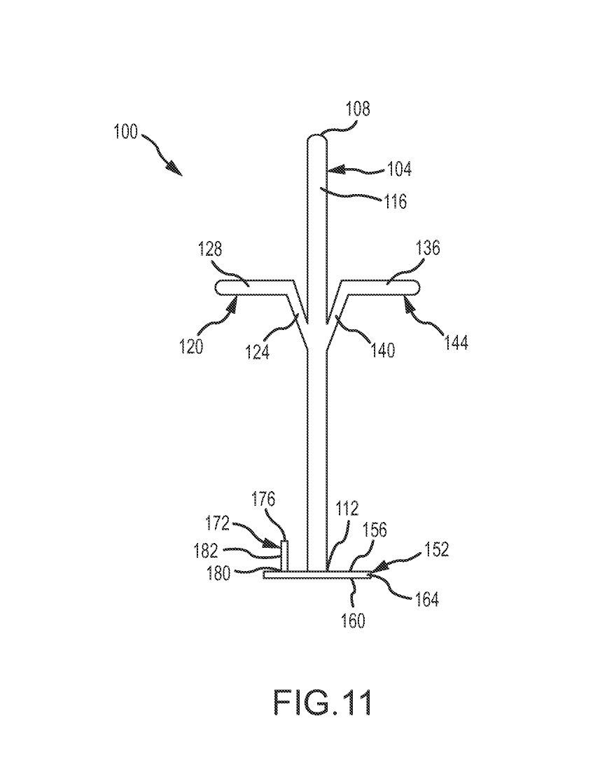

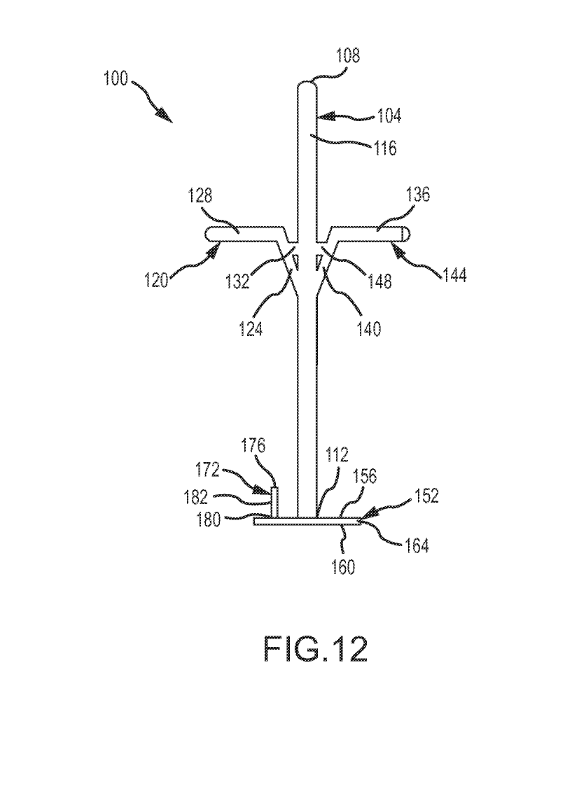

FIGS. 10, 11, and 12 demonstrate further configurations of handles with different connection points. FIG. 10 shows a first handle 120 which has a single section 124, like the embodiment in FIG. 9. However, unlike the embodiment in FIG. 9, the single section 124 in FIG. 10 is interconnected to the body element 104 at one point, not two. FIG. 11 shows a first handle 120 which has two sections 124, 128, which is similar to the embodiment in FIG. 8. However, a first handle 120 in FIG. 11 is interconnected to the body element 104 at only a single point. Lastly, FIG. 12 shows a three-sided handle where a first handle 120 has two points of interconnection to the body element 104. However, unlike previously described embodiments, the third section 132 of this handle 120 does not interconnect with the end of another section. Rather, this third section 132 is interconnected to the side of another section, 124 or 128, and the body element 104.

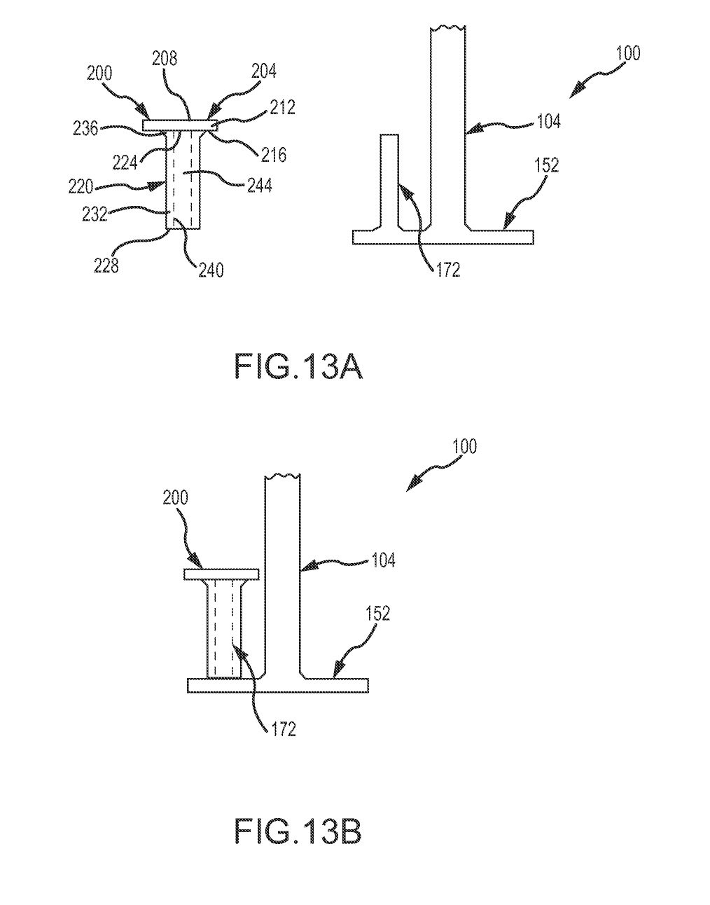

FIGS. 13A and 13B show an additional accessory, a stem cap 200. The stem cap 200 fits over the stem 172 and provides a surface area where non-pneumatic sources of power may finish driving an elongated member. The stem cap 200 is comprised of a stem cap body 220 and a stem cap flange 204.

The stem cap body 220 has a first end 224 and a second end 228, and these two ends are connected by an edge 232, which is cylindrically-shaped. The stem cap body 220 also has an interior surface 240 which creates an interior space 244 within the stem cap. This space 244 is configured to fit over the stem 172 on the tamping tool 100.

The second component of the stem cap 200 is the stem cap flange 204. The stem cap flange 204 has a first end 208 and a second end 216, and these two ends are joined by a cylindrically-shaped edge 212. As depicted, the second end 216 of the stem cap flange 204 is interconnected with the first end 224 of the stem cap body 220. In other embodiments, a person who is skilled in the art may find other points of interconnection between the stem cap flange 204 and the stem cap body 220 advantageous. For example, an interconnection between the second end 228 of the step cap body 220 and the second end 216 of the stem cap flange 204. The stem cap body 220 may also interconnect with the step cap flange 204 at a point between the first end 208 and the second end 216 of the flange 204.

A joining region 236 may surround the interconnection between the stem cap flange 204 and the stem cap body 220. This joining region 326 may be the sole mechanism to secure the two elements, or the joining region 236 may aid another mechanism which secures the two elements. It is also possible that the joining region 236 may serve another purpose altogether such as the dissipation of mechanical stresses which would otherwise accumulate if the interconnection between the stem cap body 220 and the stem cap flange 204 was a flush 90 degrees. It should be understood that the aforementioned roles for the joining region are not exhaustive or necessarily exclusive to one another.

Any one of the aforementioned embodiments may have elements comprised of at least one of metal, alloy, wood, plastic, or any other material which may allow the stem to translate a downward force applied thereto into a downward force applied to the body element.

Any one of the aforementioned embodiments may have the body element-flange joining region, flange-stem joining region, stem cap body-stem cap flange joining region comprised of at least one of metal welding, plastic welding, glue, material from the stem, material from the body element, material from the flange, material from the stem cap body, material from the stem cap flange, and any other material which allows interconnection between the body element and flange, flange and stem, and stem cap body and stem cap flange.

While illustrative embodiments of the disclosure have been described in detail herein, it is to be understood that the inventive concepts may be otherwise variously embodied and employed, and that the appended claims are intended to be construed to include such variations, except as limited by the prior art.

| Element Name | Element Number |
|---|---|
| Tamping Tool | 100 |
| Body Element | 104 |
| First End of Body Element | 108 |
| Second End of Body Element | 112 |
| Edge of Body Element | 116 |
| First Handle | 120 |
| First Section of First Handle | 124 |
| Second Section of First Handle | 128 |
| Third Section of First Handle | 132 |
| Second Handle | 136 |
| First Section of Second Handle | 140 |
| Second Section of Second Handle | 144 |
| Third Section of Second Handle | 148 |
| Flange | 152 |
| First End of Flange | 156 |
| Second End of Flange | 160 |
| Edge of Body Element | 164 |
| Joining Region between Body | 168 |
| Element and Flange | |
| Stem | 172 |
| First End of Stem | 176 |
| Second End of Stem | 180 |
| Edge of Stem | 182 |
| Joining Region between Stem and | 184 |
| Flange | |
| Interior Surface of Body Element | 188 |
| Interior Surface of Flange | 192 |
| Interior Space of Tamping tool 100 | 196 |
| Stem Cap | 200 |
| Stem Cap Flange | 204 |
| First End of Stem Cap Flange | 208 |
| Edge of Stem Cap Flange | 212 |
| Second End of Stem Cap Flange | 216 |
| Stem Cap Body | 220 |
| First End of Stem Cap Body | 224 |
| Second End of Stem Cap Body | 228 |
| Edge of Stem Cap Body | 232 |
| Joining Region between Stem Cap | 236 |
| Flange and Stem Cap Body | |
| Interior Surface of Stem Cap Body | 240 |
| Interior Space of Stem Cap | 244 |

What is claimed is:

1. A tamping tool configured to drive an elongated member into an object, the tamping tool comprising:
a body element having a first end and a second end connected by at least one edge, the body element being hollow such that the first end encapsulates an interior space within the body element, the second end comprising an opening to the interior space within the body element; and
a stem having a first end and a second end connected by at least one edge, wherein the stem is configured to translate a downward force applied thereto into a downward force applied to the body element, and the stem is positioned closer to the second end than the first end.

2. The tamping tool in claim 1, wherein the stem is operatively interconnected to a flange, which is operatively interconnected to the body element, the flange having a first end and a second end connected by at least one edge.

3. The tamping tool in claim 2, wherein the first end of the flange is operatively interconnected to at least one of the second end of the body element, the midpoint between the first end and the second end of the body element, and a point therebetween.

4. The tamping tool in claim 2, wherein the first end of the flange is operatively interconnected to at least one of the second end of the stem, the midpoint between the first end and the second end of the stem, and a point therebetween.

5. The tamping tool in claim 2, wherein the at least one edge of the flange is cylindrically-shaped.

6. The tamping tool in claim 2, wherein an operative interconnection between the stem and the flange as well as the flange and body element is comprised from at least one of metal welding, plastic welding; glue, material from the stem, material from the flange, and material from the body element.

7. The tamping tool in claim 1, wherein a first handle is operatively interconnected to the body element, wherein the first handle is configured to allow a user to control the tamping tool while it is in operation.

8. The tamping tool in claim 7, wherein a second handle is also operatively interconnected to the body element.

9. The tamping tool in claim 8, wherein the first handle and the second handle each have at least one section.

10. The tamping tool in claim 9, wherein the first handle and the second handle each have three sections such that a first section is operatively interconnected to the body element and extends outwardly from the body element, a second section is operatively interconnected to the first section and extends downwardly and substantially parallel to the body element, and a third section is operatively interconnected to the second section and the body element, and the third section extends towards the body element.

11. The tamping tool in claim 1, wherein the at least one edge of the body element is cylindrically-shaped.

12. The tamping tool in claim 1, wherein a distance between the first end and the second end of the body element is between 8′ and 12′, and the inner space of the tamping tool has a diameter between ½″ and 1″.

13. The tamping tool in claim 12, wherein the distance between the first end and the second end of the body element is between 8′ and 10′, and the inner space of the tamping tool has a diameter between ⅝″ and ¾″.

14. The tamping tool in claim 1, wherein at least one of the body and stem are comprised of at least one of metal, alloy, wood, and plastic.

15. The tamping tool in claim 1, wherein a stem cap is configured to fit over the stem and provide a greater surface area at the first end of the stem such the stem translates a downward force applied thereto into a downward force applied to the body element.

16. A hand-held tool for driving a ground rod into the Earth, comprising:
a body element having a first end and a second end connected by at least one edge, the body element being hollow such that the first end encapsulates an interior space within the body element, the second end comprising an opening to the interior space within the body element; and
a flange having a first end and a second end connected by at least one edge, wherein the flange is configured to translate a downward force applied thereto into a downward force applied to the body element.

17. The hand-held tool in claim 16, wherein a stem is operatively interconnected to the flange, which is operatively interconnected to the body element, the stem having a first end and a second end connected by at least one edge.

18. The hand-held tool in claim 17, wherein the first end of the flange is operatively interconnected to at least one of the second end of the body element, the midpoint between the first end and the second end of the body element, and a point therebetween.

19. The hand-held tool in claim 17, wherein the first end of the flange is operatively interconnected to at least one of the second end of the stem, the midpoint between the first end and the second end of the stem, and a point therebetween.

20. The hand-held tool in claim 16, wherein a first handle is operatively interconnected to the body element, wherein the first handle is configured to allow a user to control the tamping tool while it is in operation.
